(19) United States
(12) Patent Application Publication
(10) Pub. No.: US 2005/0145347 A1
(43) Pub. Date: Jul. 7, 2005

(54) Sun shade

(76) Inventors: Louise Ann Dawson, Auckland (NZ); Eileen Marie Hoey-Slocombe, Benowa Waters (AU)

Correspondence Address: Dr. O. M. (Sam) Zaghmout, 8509 Kernon Ct, Lorton, VA, 22079, US

(21) Appl. No.: 10/996,368

(22) Filed: Nov. 26, 2004

(30) Foreign Application Priority Data
Dec. 5, 2003 (NZ) 529992

(51) Int. Cl. E06B 9/08

(52) U.S. Cl. 160/370.21

(57) ABSTRACT

As shown in FIG. 1, there is a sun shade 1, having a sheet material 3 with an envelope portion 4, and an attachment means 9 distinct from the sheet material, the sun shade being such that when it is in use it engages an upper part of a vehicle door, or the window thereof, by way of the envelope portion 4 such that the sheet material 3 substantially covers the window of the vehicle door, and wherein the attachment means 9 can engage a lower part of the door to provide a force to the sheet material to maintain the sheet material in place over the window.

### CROSS-REFERENCE TO RELATED APPLICATION

This application claims the benefit of New Zealand patent application No. 529992 dated 5 Dec. 2003. The entire content of this application is incorporated herein by the reference.

### FEDERALLY SPONSORED RESEARCH

Not Applicable.

### SEQUENCE LISTING OR PROGRAM

Not Applicable.

### FIELD OF INVENTION

This invention relates to a sun shade. A particularly preferred form of the invention relates to a sun shade for use with motor vehicles.

### BACKGROUND

It is known to use a sun shade to cover a motor vehicle window so as to provide shade to an occupant traveling within the vehicle. A number of such known shades can be problematic in that they make it difficult or impractical to have the window open without compromising the ability of the shade to stay in place. For example it is known to attach a shade directly to the glass of a window by way of a suction cup or similar. Because the shade attaches to the glass it is not practicable to have the window wound down while traveling. It is according an object of at least one form of the present invention to go some way towards addressing the above problem, or to at least provide the public with a useful choice.

The term “comprises”, or comprising, or derivatives thereof, if and when used herein, should be interpreted non-exclusively—ie to mean “consisting of or including”.

### SUMMARY OF INVENTION

According to one aspect of the invention there is provided a sun shade, having a sheet material with an envelope portion, and an attachment means distinct from the sheet material, the sun shade being such that when it is in use it engages an upper part of a vehicle door, or a window thereof, by way of the envelope portion such that the sheet material substantially covers the window of the vehicle door, and wherein the attachment means can engage a lower part of the door to provide a force to the sheet material to maintain the sheet material in place over the window.

Optionally when the shade is in use the sheet material is substantially on only one side of the vehicle door except that the envelope portion extends over the top of the vehicle door, or the window thereof, to an upper external part of the door.

Optionally the sheet material is a two-way stretch cloth—eg one having elastic properties.

Optionally the attachment means comprises a length of filamentary material (eg a strap).

Optionally the attachment means has a buckle to enable adjustment of tension on the sheet material when the sun shade is in use.

Optionally the attachment means is attached to and extends from or adjacent a lower part of the sheet material.

Optionally the strap is threaded through an aperture or space in a base portion of the sheet material.

Optionally the sun shade has a sleeve portion along a base portion of the sheet material such that a support rod (eg a tube) can or does extend through the sleeve to stabilise the sheet material when the sun shade is in use.

Optionally the rod is substantially made from aluminium.

Optionally the rod has two parts which can telescope with respect to one another to adjust the effective length of the rod to accommodate smaller or larger vehicle doors/windows.

Optionally the rod has a protective cap positioned at each end part of the rod.

Optionally the attachment means comprises an engagement head (eg a clip or hook) which can be engaged with the base portion of the vehicle door, to a handle of the door, or with an arm rest of the door. Such engagement of the handle or the arm rest should be taken to be engagement at a lower part of the door without limiting what is meant by engaging a lower part of the door.

Optionally the engagement head is attached to the strap by threading the strap through an aperture of the head.

Optionally the head is made up, at least in part, from suitable metallic substance—eg galvanised steel which may or may not have a soft covering.

According to another aspect of the invention there is provided a sun shade, having a sheet material with an envelope portion, and an attachment means distinct from the sheet material;
the sheet material comprising a two way stretch cloth and having a support rod extending along a lower part of the sheet material to stabilise the sheet material when the shade is in use;
the attachment means having a length of filamentary material attached at or adjacent a lower part of the sheet material;
the sun shade being such that when it is in use it can engage an upper part of a vehicle door, or the window thereof, by way of the envelope portion such that the sheet material substantially covers the window of the vehicle door, and wherein the attachment means can engage a lower part of the door and the filamentary material can be set to provide a force to the sheet material to maintain the sheet material in place over the window.

### DESCRIPTION OF THE DRAWINGS

Some preferred embodiments of the invention will now be described by way of example, and with reference to the accompanying drawings, of which:

FIG. 1 is a perspective view of a sun shade, showing the shade as if fitted to a door of a motor vehicle,

FIG. 2 is a side view showing the sun shade fitted to a motor vehicle door,

FIGS. 3 and 4 show detail of a telescoping tube forming part of the shade, and

FIG. 5 shows detail of an engagement head forming part of the shade.

### DETAILED DESCRIPTION

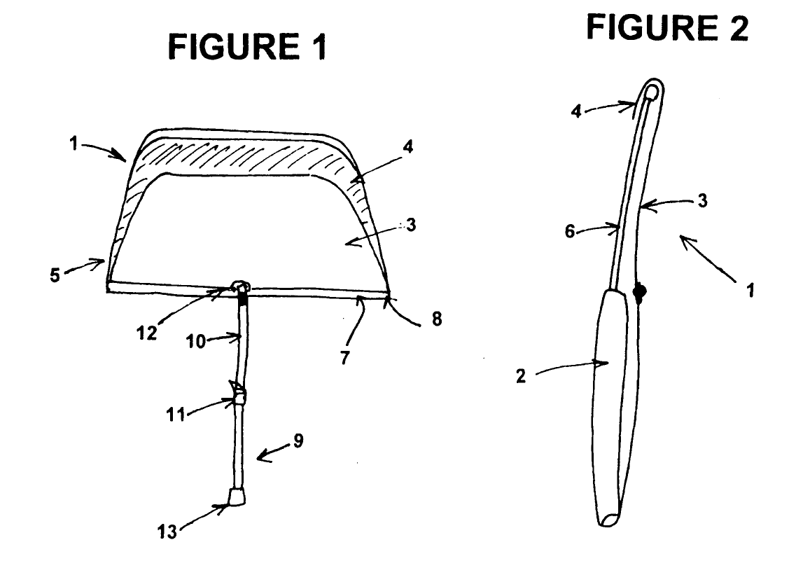

Referring to FIGS. 1 and 2, the sun shade 1 is shown in a normal in-use orientation, and in the case of FIG. 2, actually attached to a motor vehicle door 2. The sun shade comprises a flexible elastic sheet material in the form of a mesh fabric 3 which is engaged over the vehicle door or window by way of an envelope portion 4. The envelope portion 4 is part of the overall mesh fabric 1. More specifically, the envelope portion 4 fits snugly over the top of the vehicle door, or in some cases the window thereof, and extends at least partly down the sides 5 of the door 2, or the window thereof.

As shown in FIG. 2, when the shade 1 is in use the envelope portion 4 passes from inside the door and to the upper exterior of the door, or the window thereof, but does not completely cover the exterior of the window 6. In some alternative embodiments of the invention the exterior of the window may in fact be substantially completely covered by the mesh fabric 3, although that is not the preferred embodiment of the invention.

Referring to FIG. 1, a telescoping aluminium tube 7 is arranged within a sleeve 8 at a base part of the mesh fabric 3. The purpose of the tube 7 is to provide stability to the mesh fabric 3 when the shade 1 is in use. The telescoping nature of the tube 7, together with the elastic qualities of the mesh fabric 3, means that the shade can be used with vehicles of various sizes—ie it is size adjustable.

An attachment means 9 comprising a strap 10 and a buckle 11 extends downwards from a lower part of the mesh fabric 3. The strap 10 may be elasticized although that is not essential. As shown in FIGS. 1 and 2, the strap 10 is threaded through an aperture 12 in the mesh fabric 3, and consequently extends around the tube 7. The tube 7 assists in holding the mesh fabric 3 substantially close against the window 6, and also serves as reinforcement for the aperture 12—ie to resist the mesh fabric 3 tearing in the vicinity of the aperture 12.

Included in the attachment means is an attachment head in the form of a hook 13 to which the strap 10 is attached. The strap 10 is threaded through an aperture in the hook 13 and is also threaded through the buckle 11 so that the effective length of the strap 10 can be adjusted. The hook can thus be engaged with the door below the tube 7 and the strap pulled tight or otherwise adjusted to tension the mesh fabric 3, thus holding the sun shade firmly in place against or adjacent the door.

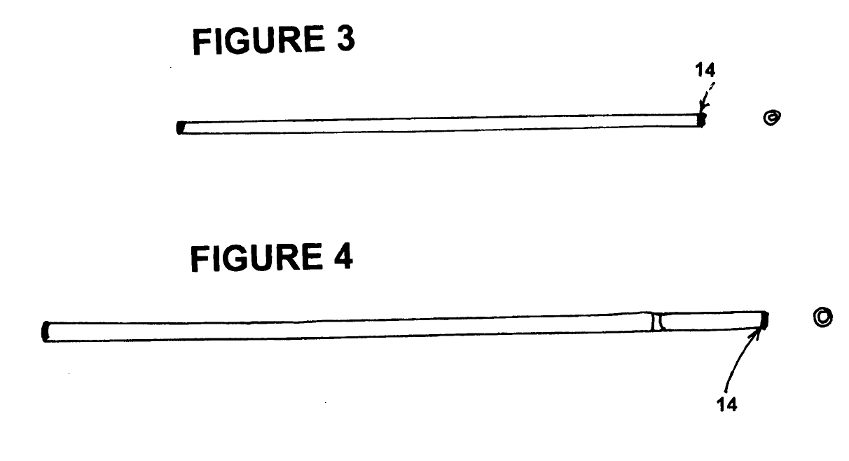

FIGS. 3 and 4 show detail of the two telescoping parts of the tube 7. More particularly, FIG. 3 shows the smaller part which telescopes inside and beyond the larger part shown at FIG. 4. Each end of the tube 7 which is adjacent the ends of the sleeve 8 of the mesh fabric 3 has a respective plastic or rubber cap 14 to prevent the tube 7 scratching or otherwise marking the vehicle door.

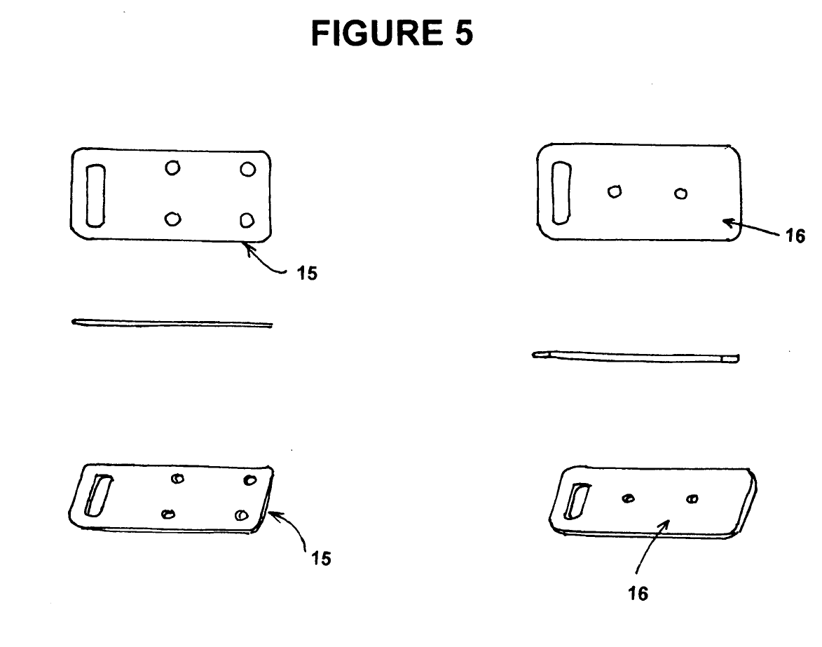

FIG. 5 shows the various details of the hook 13 prior to it being bent into a hook shape. The hook is preferably formed from sheet metal 15 and has a soft over-mould 16 to prevent marking of the vehicle door. The over-mould 16 may be formed from a suitable synthetic substance, for example from santoprene™.

Those skilled in the art will appreciate that the shade 1 can be fitted around a vehicle door and the window opened without compromising the ability of the shade to stay in place and perform its shade function. This is especially the case when the envelope portion of the shade is arranged to encapsulate the top of the door. However the shade can be used with the envelope portion extending around the top of the door window glass, as opposed to the door per se, although that would present limitations in terms of the amount of shade protection provided if the window was partially wound down.

While some preferred forms of the invention have been described by way of example it should be appreciated that improvements and modifications can occur without departing from the scope of the appended claims.

1. A sun shade, having a sheet material with an envelope portion, and an attachment means distinct from the sheet material, the sun shade being such that when it is in use it engages an upper part of a vehicle door, or the window thereof, by way of the envelope portion such that the sheet material substantially covers the window of the vehicle door, and wherein the attachment means can engage a lower part of the door to provide a force to the sheet material to maintain the sheet material in place over the window.

2. A shade according to claim 1, formed such that when the shade is in use it functions with the sheet material substantially on only one side of the vehicle door except that the envelope portion extends over the top of the vehicle door, or the window thereof, to an upper external part of the door.

3. A shade according to claim 1, wherein the sheet material comprises a two-way stretch cloth.

4. A shade according to claim 1, wherein the attachment means has a length of filamentary material.

5. A shade according to claim 1, wherein the attachment means has a buckle to enable adjustment of tension on the sheet material when the shade is in use.

6. A shade according to claim 1, wherein the attachment means is attached to and extends from or adjacent a lower part of the sheet material.

7. A shade according to claim 1, wherein the attachment means is threaded through an aperture or space in a base portion of the sheet material.

8. A shade according to claim 1, wherein the shade has a sleeve portion along a base portion of the sheet material such that a support rod can or does extend through the sleeve to stabilise the sheet material when the sun shade is in use.

9. A shade according to claim 1, wherein the shade has a sleeve portion along a base portion of the sheet material such that a support rod can or does extend through the sleeve to stabilise the sheet material when the sun shade is in use, and wherein the rod has two parts which can telescope with respect to one another to adjust an effective length of the rod to accommodate smaller or larger vehicle doors/windows.

10. A shade according to claim 1, wherein the shade has a sleeve portion along a base portion of the sheet material such that a support rod can or does extend through the sleeve to stabilise the sheet material when the sun shade is in use, and wherein the rod has two parts which can telescope with respect to one another to adjust an effective length of the rod to accommodate smaller or larger vehicle doors/windows, and wherein the rod has a protective cap positioned at each end part of the rod.

11. A shade according to claim 1, wherein the attachment means has an engagement head which can be engaged with a base portion of the vehicle door, to a handle of the door, or with an arm rest of the door.

12. A shade according to claim 1, wherein the attachment means has an engagement head which can be engaged with a base portion of the vehicle door, to a handle of the door, or with an arm rest of the door, and wherein the engagement head is attached to the rest of the attachment means by threading part of the attachment means through an aperture of the head.

13. A sun shade, having a sheet material with an envelope portion, and an attachment means distinct from the sheet material;
the sheet material comprising a two way stretch cloth and having a support rod extending along a lower part of the sheet material to stabilise the sheet material when the shade is in use;
the attachment means having a length of filamentary material attached at or adjacent a lower part of the sheet material;
the sun shade being such that when it is in use it can engage an upper part of a vehicle door, or a window thereof, by way of the envelope portion such that the sheet material substantially covers the window of the vehicle door, and wherein the attachment means can engage a lower part of the door and the filamentary material can be set to provide a force to the sheet material to maintain the sheet material in place over the window.
